(19) United States
(12) Patent Application Publication
(10) Pub. No.: US 2019/0068427 A1
(43) Pub. Date: Feb. 28, 2019

(54) METHOD FOR PERFORMING RANDOM ACCESS PROCEDURE FOR SINGLE TONE TRANSMISSION IN WIRELESS COMUNICATION SYSTEM AND APPARATUS THEREFOR

(71) Applicant: LG ELECTRONICS INC., Seoul (KR)

(72) Inventors: Daesung HWANG, Seoul (KR); Yunjung YI, Seoul (KR)

(73) Assignee: LG ELECTRONICS INC., Seoul (KR)

(21) Appl. No.: 16/081,009

(22) PCT Filed: Mar. 9, 2017
(86) PCT No.: PCT/KR2017/002550

§ 371 Date: Aug. 29, 2018

Related U.S. Application Data
(60) Provisional application No. 62/306,602, filed on Mar. 10, 2016.
(60) Provisional application No. 62/316,542, filed on Mar. 31, 2016.

(51) Int. Cl. H04L 27/26; H04W 72/04; H04W 74/08; H04W 76/11

(52) U.S. Cl. CPC H04L 27/2666; H04W 76/11; H04W 74/0833; H04W 72/0453

(57) ABSTRACT

Disclosed in the present application is a method for performing, at a terminal, a random access procedure for narrow band communication in a wireless communication system. Specifically, the method comprises the steps of: receiving information on a starting subcarrier index for a random access channel; allocating a frequency resource to the random access channel in a subcarrier index order from the starting subcarrier index by a predetermined number of subcarriers in one resource block; and transmitting the random access channel to a base station using the allocated frequency resource, wherein the step of allocating the frequency resource comprises a step of allocating the remaining frequency resources to the random access channel in the subcarrier index order from a specific subcarrier in the one resource block if a subcarrier index to be allocated is larger than a maximum subcarrier index in the one resource block.

### TECHNICAL FIELD

The present invention relates to a narrow band communication for supporting IoT service in a wireless communication system, and more particularly, to a method of performing a random access procedure for single tone transmission and an apparatus therefor.

### BACKGROUND ART

As an example of a wireless communication system to which the present invention is applicable, a 3^{rd} Generation Partnership Project (3GPP) Long Term Evolution (LTE) communication system will be schematically described.

FIG. 1 is a diagram showing a network structure of an Evolved Universal Mobile Telecommunications System (E-UMTS) as a mobile communication system. The E-UMTS is an evolved form of the UMTS and has been standardized in the 3GPP. Generally, the E-UMTS may be called a Long Term Evolution (LTE) system. For details of the technical specifications of the UMTS and E-UMTS, refer to Release 7 and Release 8 of “3rd Generation Partnership Project; Technical Specification Group Radio Access Network”.

Referring to FIG. 1, the E-UMTS mainly includes a User Equipment (UE), base stations (or eNBs or eNode Bs), and an Access Gateway (AG) which is located at an end of a network (E-UTRAN) and which is connected to an external network. Generally, an eNB can simultaneously transmit multiple data streams for a broadcast service, a multicast service and/or a unicast service.

One or more cells may exist per eNB. The cell is set to use a bandwidth such as 1.25, 2.5, 5, 10, 15 or 20 MHz to provide a downlink or uplink transmission service to several UEs. Different cells may be set to provide different bandwidths. The eNB controls data transmission or reception of a plurality of UEs. The eNB transmits downlink (DL) scheduling information of DL data so as to inform a corresponding UE of time/frequency domain in which data is transmitted, coding, data size, and Hybrid Automatic Repeat and reQest (HARQ)-related information. In addition, the eNB transmits uplink (UL) scheduling information of UL data to a corresponding UE so as to inform the UE of a time/frequency domain which may be used by the UE, coding, data size and HARQ-related information. An interface for transmitting user traffic or control traffic can be used between eNBs. A Core Network (CN) may include the AG and a network node or the like for user registration of the UE. The AG manages mobility of a UE on a Tracking Area (TA) basis. One TA includes a plurality of cells.

Although wireless communication technology has been developed up to Long Term Evolution (LTE) based on Wideband Code Division Multiple Access (WCDMA), the demands and the expectations of users and providers continue to increase. In addition, since other radio access technologies have been continuously developed, new technology evolution is required to secure high competitiveness in the future. Decrease in cost per bit, increase in service availability, flexible use of a frequency band, simple structure, open interface, suitable User Equipment (UE) power consumption and the like are required.

### DISCLOSURE OF THE INVENTION

### Technical Task

Based on the aforementioned discussion, the present invention proposes a method of performing a random access procedure for single tone transmission in a wireless communication system and an apparatus therefor.

### Technical Solution

To achieve these and other advantages and in accordance with the purpose of the present invention, as embodied and broadly described, according to one embodiment, a method of performing a random access procedure, which is performed by a user equipment (UE) for narrow band communication in a wireless communication system, includes the steps of receiving information on a starting subcarrier index for a random access channel, allocating frequency resources to the random access channel as many as the predetermined number of subcarriers from the starting subcarrier index in an order of a subcarrier index in a single resource block, and transmitting the random access channel to a base station using the allocated frequency resources. In this case, if a subcarrier index to be assigned is greater than the maximum subcarrier index in the single resource block, the step of allocating the frequency resources includes the step of allocating the remaining frequency resources to the random access channel from a specific subcarrier in an order of a subcarrier index in the single resource block.

To further achieve these and other advantages and in accordance with the purpose of the present invention, according to a different embodiment, a user equipment (UE) in a wireless communication system includes a wireless communication module and a processor configured to receive information on a starting subcarrier index for a random access channel in a manner of being connected with the wireless communication module, the processor configured to allocate frequency resources to the random access channel as many as the predetermined number of subcarriers from the starting subcarrier index in an order of a subcarrier index in a single resource block, the processor configured to transmit the random access channel to a base station using the allocated frequency resources. In this case, if a subcarrier index to be assigned is greater than the maximum subcarrier index in the single resource block, the processor is configured to allocate the remaining frequency resources to the random access channel from a specific subcarrier in an order of a subcarrier index in the single resource block.

Preferably, at least one guard band can be configured in the single resource block to prevent interference from a legacy system. In this case, the specific subcarrier may correspond to a subcarrier of the minimum index except a subcarrier designated as the at least one guard band in the single resource block.

Preferably, the UE can receive a random access response signal from the base station in response to the random access channel. In particular, the random access response signal can be masked with an identifier which is calculated by a time resource index at which the random access channel is transmitted. More preferably, a time resource for receiving the random access response signal can be determined based on the starting subcarrier index.

### Advantageous Effects

According to embodiments of the present invention, it is able to efficiently perform a random access procedure for single tone transmission when a narrow band communication for supporting IoT service is performed in a wireless communication system.

The effects of the present invention are not limited to the above-described effects and other effects which are not described herein will become apparent to those skilled in the art from the following description.

### DESCRIPTION OF DRAWINGS

FIG. 1 is a diagram schematically illustrating a network structure of an E-UMTS as an exemplary radio communication system;

FIG. 2 is a diagram illustrating structures of a control plane and a user plane of a radio interface protocol between a UE and an E-UTRAN based on the 3GPP radio access network specification;

FIG. 3 is a diagram illustrating physical channels used in a 3GPP system and a general signal transmission method using the same;

FIG. 4 is a diagram illustrating the structure of a radio frame used in an LTE system;

FIG. 5 is a diagram illustrating the structure of a DL radio frame used in an LTE system;

FIG. 6 is a diagram illustrating the structure of a UL subframe in an LTE system;

FIG. 7 is a diagram showing operations of a UE and an eNB in a contention based random access procedure provided in an LTE system;

FIG. 8 is a diagram showing operations of a UE and an eNB in a non-contention based random access procedure provided in an LTE system;

FIG. 9 is a flowchart illustrating an example of performing a random access procedure for narrow band communication according to an embodiment of the present invention;

FIG. 10 is a block diagram of a communication apparatus according to an embodiment of the present invention.

### BEST MODE

### Mode for Invention

The configuration, operation and other features of the present invention will be understood by the embodiments of the present invention described with reference to the accompanying drawings. The following embodiments are examples of applying the technical features of the present invention to a 3rd Generation Partnership Project (3GPP) system.

Although the embodiments of the present invention will be described based on an LTE system and an LTE-advanced (LTE-A) system, the LTE system and the LTE-A system are purely exemplary and the embodiments of the present invention can be applied to any communication system corresponding to the aforementioned definition. In the present disclosure, a base station (eNB) may be used as a broad meaning including a remote radio head (RRH), an eNB, a transmission point (TP), a reception point (RP), a relay, etc.

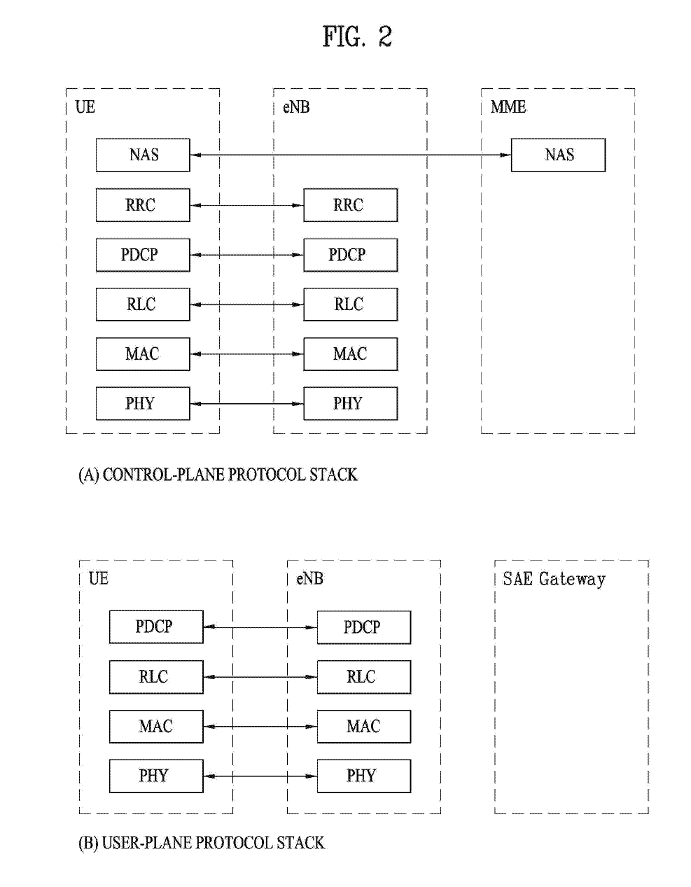

FIG. 2 is a diagram illustrating structures of a control plane and a user plane of a radio interface protocol between a UE and an E-UTRAN based on 3GPP radio access network specifications. The control plane refers to a path used for transmission of control messages, which is used by the UE and the network to manage a call. The user plane refers to a path in which data generated in an application layer, e.g. voice data or Internet packet data, is transmitted.

A physical layer of a first layer provides an information transfer service to an upper layer using a physical channel. The physical layer is connected to a media access control (MAC) layer of an upper layer via a transmission channel. Data is transmitted between the MAC layer and the physical layer via the transmission channel Data is also transmitted between a physical layer of a transmitter and a physical layer of a receiver via a physical channel. The physical channel uses time and frequency as radio resources. Specifically, the physical channel is modulated using an orthogonal frequency division multiple Access (OFDMA) scheme in DL and is modulated using a single-carrier frequency division multiple access (SC-FDMA) scheme in UL.

The MAC layer of a second layer provides a service to a radio link control (RLC) layer of an upper layer via a logical channel. The RLC layer of the second layer supports reliable data transmission. The function of the RLC layer may be implemented by a functional block within the MAC layer. A packet data convergence protocol (PDCP) layer of the second layer performs a header compression function to reduce unnecessary control information for efficient transmission of an Internet protocol (IP) packet such as an IPv4 or IPv6 packet in a radio interface having a relatively narrow bandwidth.

A radio resource control (RRC) layer located at the bottommost portion of a third layer is defined only in the control plane. The RRC layer controls logical channels, transmission channels, and physical channels in relation to configuration, re-configuration, and release of radio bearers. A radio bearer refers to a service provided by the second layer to transmit data between the UE and the network. To this end, the RRC layer of the UE and the RRC layer of the network exchange RRC messages. The UE is in an RRC connected mode if an RRC connection has been established between the RRC layer of the radio network and the RRC layer of the UE. Otherwise, the UE is in an RRC idle mode. A non-access stratum (NAS) layer located at an upper level of the RRC layer performs functions such as session management and mobility management.

A cell constructing an eNB is configured by one of bandwidths among 1.25, 2.5, 5, 10, 15, and 20 MHz and provides DL or UL transmission service to a plurality of UEs. Cells different from each other can be configured to provide a different bandwidth.

DL transmission channels for data transmission from the network to the UE include a broadcast channel (BCH) for transmitting system information, a paging channel (PCH) for transmitting paging messages, and a DL shared channel (SCH) for transmitting user traffic or control messages. Traffic or control messages of a DL multicast or broadcast service may be transmitted through the DL SCH or may be transmitted through an additional DL multicast channel (MCH). Meanwhile, UL transmission channels for data transmission from the UE to the network include a random access channel (RACH) for transmitting initial control messages and a UL SCH for transmitting user traffic or control messages. Logical channels, which are located at an upper level of the transmission channels and are mapped to the transmission channels, include a broadcast control channel (BCCH), a paging control channel (PCCH), a common control channel (CCCH), a multicast control channel (MCCH), and a multicast traffic channel (MTCH).

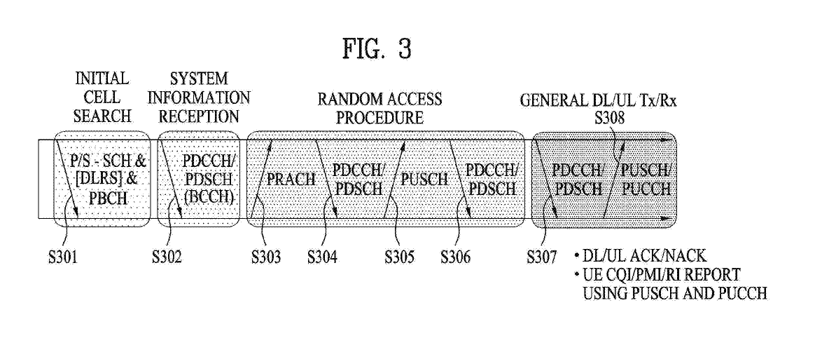

FIG. 3 is a diagram illustrating physical channels used in a 3GPP system and a general signal transmission method using the same.

When power is turned on or the UE enters a new cell, the UE performs an initial cell search procedure such as acquisition of synchronization with an eNB (S301). To this end, the UE may adjust synchronization with the eNB by receiving a primary synchronization channel (P-SCH) and a secondary synchronization channel (S-SCH) from the eNB and acquire information such as a cell identity (ID). Thereafter, the UE may acquire broadcast information within the cell by receiving a physical broadcast channel from the eNB. In the initial cell search procedure, the UE may monitor a DL channel state by receiving a downlink reference signal (DL RS).

Upon completion of the initial cell search procedure, the UE may acquire more detailed system information by receiving a physical downlink control channel (PDCCH) and receiving a physical downlink shared channel (PDSCH) based on information carried on the PDCCH (S302).

Meanwhile, if the UE initially accesses the eNB or if radio resources for signal transmission to the eNB are not present, the UE may perform a random access procedure (S303 to S306) with the eNB. To this end, the UE may transmit a specific sequence through a physical random access channel (PRACH) as a preamble (S303 and S305) and receive a response message to the preamble through the PDCCH and the PDSCH associated with the PDCCH (S304 and S306). In the case of a contention-based random access procedure, the UE may additionally perform a contention resolution procedure.

After performing the above procedures, the UE may receive a PDCCH/PDSCH (S307) and transmit a physical uplink shared channel (PUSCH)/physical uplink control channel (PUCCH) (S308), as a general UL/DL signal transmission procedure. Especially, the UE receives downlink control information (DCI) through the PDCCH. The DCI includes control information such as resource allocation information for the UE and has different formats according to use purpose thereof.

Meanwhile, control information that the UE transmits to the eNB on UL or receives from the eNB on DL includes a DL/UL acknowledgment/negative acknowledgment (ACK/NACK) signal, a channel quality indicator (CQI), a precoding matrix index (PMI), a rank indicator (RI), and the like. In the 3GPP LTE system, the UE may transmit the control information such as CQI/PMI/RI through a PUSCH and/or a PUCCH.

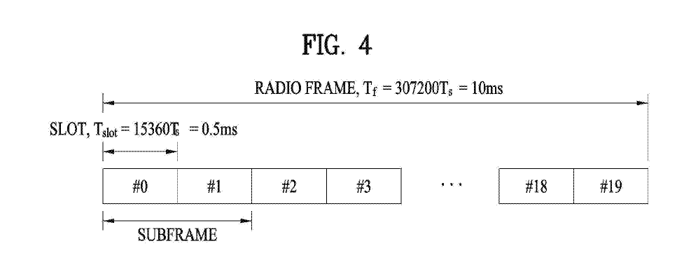

FIG. 4 is a diagram illustrating the structure of a radio frame used in an LTE system.

Referring to FIG. 4, the radio frame has a length of 10 ms (327200×Ts) and includes 10 equal-sized subframes. Each of the subframes has a length of 1 ms and includes two slots. Each slot has a length of 0.5 ms (15360 Ts). In this case, Ts denotes a sampling time represented by Ts=1/(15 kHz×2048)=3.2552×10⁻⁸ (about 33 ns). Each slot includes a plurality of OFDM symbols in the time domain and includes a plurality of resource blocks (RBs) in the frequency domain. In the LTE system, one RB includes 12 subcarriers×7 (or 6) OFDM symbols. A transmission time interval (TTI), which is a unit time for data transmission, may be determined in units of one or more subframes. The above-described structure of the radio frame is purely exemplary and various modifications may be made in the number of subframes included in a radio frame, the number of slots included in a subframe, or the number of OFDM symbols included in a slot.

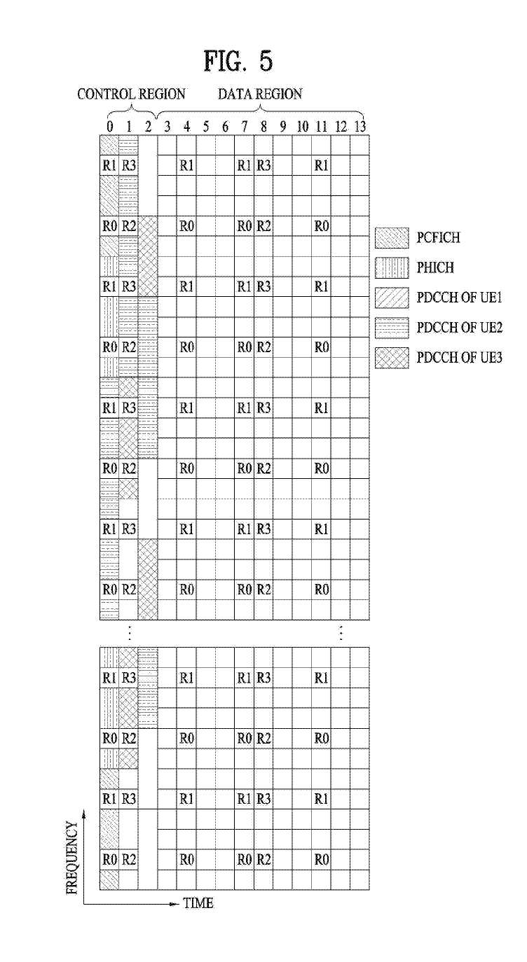

FIG. 5 is a diagram illustrating control channels included in a control region of one subframe in a DL radio frame.

Referring to FIG. 5, one subframe includes 14 OFDM symbols. The first to third ones of the 14 OFDM symbols may be used as a control region and the remaining 11 to 13 OFDM symbols may be used as a data region, according to subframe configuration. In FIG. 5, R0 to R3 represent reference signals (RSs) or pilot signals for antennas 0 to 3, respectively. The RSs are fixed to a predetermined pattern within the subframe irrespective of the control region and the data region. Control channels are allocated to resources unused for RSs in the control region. Traffic channels are allocated to resources unused for RSs in the data region. The control channels allocated to the control region include a physical control format indicator channel (PCFICH), a physical hybrid-ARQ indicator channel (PHICH), a physical downlink control channel (PDCCH), etc.

The PCFICH, physical control format indicator channel, informs a UE of the number of OFDM symbols used for the PDCCH in every subframe. The PCFICH is located in the first OFDM symbol and is configured with priority over the PHICH and the PDCCH. The PCFICH is composed of 4 resource element groups (REGs) and each of the REGs is distributed over the control region based on a cell ID. One REG includes 4 resource elements (REs). An RE indicates a minimum physical resource defined as one subcarrier by one OFDM symbol. The PCFICH value indicates values of 1 to 3 or values of 2 to 4 depending on bandwidth and is modulated using quadrature phase shift keying (QPSK).

The PHICH, physical hybrid-ARQ indicator channel, is used to carry a HARQ ACK/NACK signal for UL transmission. That is, the PHICH indicates a channel through which DL ACK/NACK information for UL HARQ is transmitted. The PHICH includes one REG and is cell-specifically scrambled. The ACK/NACK signal is indicated by 1 bit and is modulated using binary phase shift keying (BPSK). The modulated ACK/NACK signal is spread with a spreading factor (SF) of 2 or 4. A plurality of PHICHs mapped to the same resource constitutes a PHICH group. The number of PHICHs multiplexed to the PHICH group is determined depending on the number of spreading codes. The PHICH (group) is repeated three times to obtain diversity gain in the frequency domain and/or the time domain.

The PDCCH is allocated to the first n OFDM symbols of a subframe. In this case, n is an integer equal to or greater than 1, indicated by the PCFICH. The PDCCH is composed of one or more control channel elements (CCEs). The PDCCH informs each UE or UE group of information associated with resource allocation of transmission channels, that is, a paging channel (PCH) and a downlink shared channel (DL-SCH), UL scheduling grant, HARQ information, etc. The PCH and the DL-SCH are transmitted through a PDSCH. Therefore, the eNB and the UE transmit and receive data through the PDSCH except for particular control information or service data.

Information indicating to which UE or UEs PDSCH data is to be transmitted and information indicating how UEs should receive and decode the PDSCH data are transmitted on the PDCCH. For example, assuming that a cyclic redundancy check (CRC) of a specific PDCCH is masked by a radio network temporary identity (RNTI) ‘A’ and information about data transmitted using a radio resource ‘B’ (e.g. frequency location) and using DCI format ‘C’, i.e. transport format information (e.g. a transport block size, a modulation scheme, coding information, etc.), is transmitted in a specific subframe, a UE located in a cell monitors the PDCCH, i.e. blind-decodes the PDCCH, using RNTI information thereof in a search space. If one or more UEs having RNTI ‘A’ are present, the UEs receive the PDCCH and receive a PDSCH indicated by ‘B’ and ‘C’ based on the received information of the PDCCH.

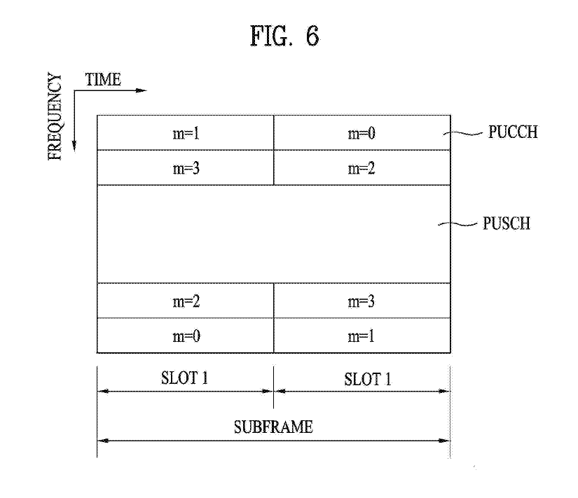

FIG. 6 is a diagram illustrating the structure of a UL subframe in an LTE system.

Referring to FIG. 6, an uplink subframe is divided into a region to which a PUCCH is allocated to transmit control information and a region to which a PUSCH is allocated to transmit user data. The PUSCH is allocated to the middle of the subframe, whereas the PUCCH is allocated to both ends of a data region in the frequency domain. The control information transmitted on the PUCCH includes an ACK/NACK, a channel quality indicator (CQI) representing a downlink channel state, an RI for Multiple Input and Multiple Output (MIMO), a scheduling request (SR) indicating a request for allocation of UL resources, etc. A PUCCH of a UE uses one RB occupying different frequencies in each slot of a subframe. That is, two RBs allocated to the PUCCH frequency-hop over the slot boundary. Particularly, PUCCHs for m=0, m=1, m=2, and m=3 are allocated to a subframe in FIG. 6.

Next, a random access (RA) procedure provided in an LTE system will be described. The RA procedure provided in the LTE system is divided into a contention based random access procedure and a non-contention based random access procedure. The contention based random access procedure or the non-contention based random access procedure is determined depending on whether a random access preamble used in the RA procedure is directly selected by a UE or is selected by an eNB.

In the non-contention based random access procedure, the UE uses a random access preamble which is directly allocated thereto by the eNB. Accordingly, if the eNB allocates the specific random access preamble only to the UE, the random access preamble is used only by the UE and other UEs do not use the random access preamble. Accordingly, since the random access preamble corresponds one-to-one to the UE which uses the random access preamble, no contention occurs. In this case, since the eNB may become aware of the UE which transmits the random access preamble as soon as the eNB receives the random access preamble, efficiency is good.

In the contention based random access procedure, since a random access preamble is arbitrarily selected from among random access preambles which may be used by the UE and is transmitted, a plurality of UEs may always use the same random access preamble. Accordingly, when the eNB receives a specific random access preamble, the eNB may not check which UE transmits the random access preamble.

The UE performs the random access procedure 1) if a UE performs initial access without RRC connection with an eNB, 2) if a UE first accesses a target cell in a handover process, 3) if a random access procedure is requested by a command of an eNB, 4) if uplink data is generated in a state in which uplink time synchronization is not performed or radio resources to be used to request radio resources are not allocated and 5) upon a restoring process due to radio link failure or handover failure.

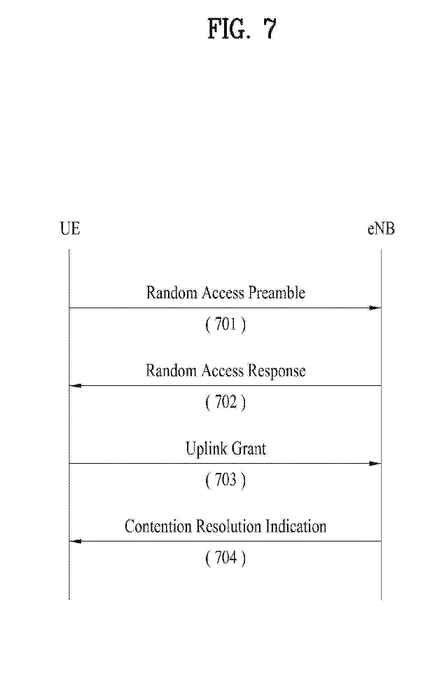

FIG. 7 is a diagram showing operations of a UE and an eNB in a contention based random access procedure provided in an LTE system.

Referring to FIG. 7, in step 701, the UE may randomly select a single random access preamble from a set of random access preambles indicated through system information or a handover command, and select and transmit Physical Random Access Channel (PRACH) resources capable of transmitting the random access preamble. At this time, the preamble is called RACH MSG 1.

In step 702, the UE attempts to receive its own random access response within a random access response reception window indicated by the eNB through the system information or the handover command, after the random access preamble is transmitted. More specifically, RACH MSG 2, that is, random access response information is transmitted in the form of a MAC PDU and the MAC PDU is sent via a PDSCH. In addition, a PDCCH is also sent in order to enable the UE to appropriately receive the information sent via the PDSCH. That is, the PDCCH includes information about the UE which should receive the PDSCH, frequency and time information of radio resources of the PDSCH and the transmission format of the PDSCH. If the UE successfully receives the PDCCH, the random access response transmitted via the PDSCH is appropriately received according to the information about the PDCCH. The random access response includes a random access preamble identity, UL grant, a temporary C-RNTI, a time alignment command, etc. The reason why the random access preamble identity is necessary is because random access response information for one or more UEs may be included in one random access response and thus it is necessary to indicate for which UE the uplink grant, the temporary C-RNTI and the time alignment command are valid. The random access preamble identity matches the random access preamble selected by the UE in step 701.

Subsequently, in step 703, if the UE has received the random access response valid for the UE, the UE processes all information included in the random access response. That is, the UE applies the time alignment command and stores the temporary C-RNTI. In addition, data which is stored in the buffer of the UE or newly generated data is transmitted to the eNB using the uplink grant. At this time, data transmitted via the uplink grant, that is, MAC PDU, is referred to as RACH MSG 3. The identity of the UE should necessarily be included in the data included in the uplink grant. This is because the eNB may not determine which UE performs the random access procedure in the contention based random access procedure and thus should identify the UE in order to perform contention resolution later. Here, there are two different schemes for including the UE identity. A first scheme is to transmit the UE's cell identity through UL grant if the UE has already received a valid cell identity allocated by a corresponding cell prior to the random access procedure. Conversely, the second scheme is to transmit the UE's unique identity if the UE has not received a valid cell identity prior to the random access procedure. In general, the unique identity is longer than the cell identity. If the UE has transmitted data through the UL Grant, the UE starts a contention resolution (CR) timer.

Finally, after the UE transmits the data including its own identity through the UL Grant included in the random access response, the UE waits for an indication from the eNB for contention resolution. That is, the UE attempts to receive the PDCCH in order to receive a specific message. Here, there are two schemes for receiving the PDCCH. As described above, the UE attempts to receive the PDCCH using its own cell identity if the identity transmitted via the UL Grant is a cell identity, and the UE attempts to receive the PDCCH using the temporary C-RNTI included in the random access response if the identity is its own unique identity. Thereafter, in the former scheme, if the PDCCH (that is, RACH MSG 4) has been received through its own cell identity before the contention resolution timer has expired, the UE determines that the random access procedure has been normally performed and completes the random access procedure. In the latter scheme, if the PDCCH has been received through the temporary C-RNTI before the contention resolution timer has expired, the UE checks data transferred by the PDSCH indicated by the PDCCH. If the unique identity of the UE is included in the data, the UE determines that the random access procedure has been normally performed and completes the random access procedure.

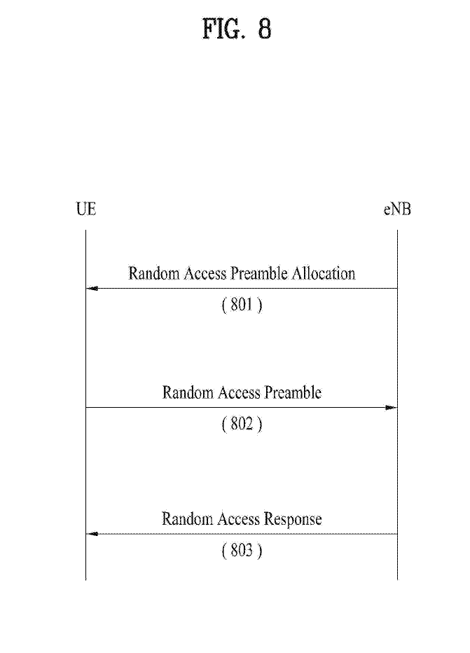

FIG. 8 is a diagram showing operations of a UE and an eNB in a non-contention based random access procedure provided in an LTE system.

As described above, in the non-contention based random access procedure, unlike the contention based random access procedure, if the random access response information is received, the UE determines that the random access procedure has been normally performed and completes the random access procedure. In addition, the non-contention random access procedure may be performed upon a handover process or when this procedure is requested by the eNB. Of course, even in these cases, the contention based random access procedure may be performed. First, for the non-contention based random access procedure, it is important to receive, from the eNB, a dedicated random access preamble which may not cause contention. In order to receive the random access preamble, a handover command and a PDCCH command may be used.

In addition, the eNB may set PRACH resources to be used when the UE transmits the random access preamble. The PRACH resources include a subframe and frequency resources to be used when the UE transmits the random access preamble.

Table 1 shows PRACH mask indices of PRACH resources which are set by the eNB with respect to the UE.

TABLE 1

| PRACH | | |
|---|---|---|
| Mask Index | Allowed PRACH (FDD) | Allowed PRACH (TDD) |
| 0 | All | All |
| 1 | PRACH Resource Index 0 | PRACH Resource Index 0 |
| 2 | PRACH Resource Index 1 | PRACH Resource Index 1 |
| 3 | PRACH Resource Index 2 | PRACH Resource Index 2 |
| 4 | PRACH Resource Index 3 | PRACH Resource Index 3 |
| 5 | PRACH Resource Index 4 | PRACH Resource Index 4 |
| 6 | PRACH Resource Index 5 | PRACH Resource Index 5 |
| 7 | PRACH Resource Index 6 | Reserved |
| 8 | PRACH Resource Index 7 | Reserved |
| 9 | PRACH Resource Index 8 | Reserved |
| 10 | PRACH Resource Index 9 | Reserved |
| 11 | Every, in the time domain, | Every, in the time domain, |
| | even PRACH opportunity | even PRACH opportunity |
| | 1^{st} PRACH Resource | 1^{st} PRACH Resource |
| | Index in subframe | Index in subframe |
| 12 | Every, in the time domain, | Every, in the time domain, |
| | odd PRACH opportunity | odd PRACH opportunity |
| | 1^{st} PRACH Resource | 1^{st} PRACH Resource |
| | Index in subframe | Index in subframe |
| 13 | Reserved | 1^{st} PRACH Resource |
| | | Index in subframe |
| 14 | Reserved | 2^{nd} PRACH Resource |
| | | Index in subframe |
| 15 | Reserved | 3^{rd} PRACH Resource |
| | | Index in subframe |

For example, in the FDD mode, the UE may transmit the random access preamble in one subframe or even subframes or odd subframes among 10 subframes according to the PRACH mask indices of Table 1.

Referring to FIG. 8, the UE receives a random access preamble allocated by the eNB in step 801 and transmits the preamble to the eNB in step 802. A method of receiving a random access response in step 803 is equal to that of the contention based random access procedure of FIG. 7.

A next generation system considers configuring a UE of low cost/low specification mainly performing data communication such as metering, measuring a water level, utilizing a surveillance camera, inventory reporting of a vending machine and the like. Although the UE has low device complexity and low power consumption, the UE intends to provide an appropriate processing ratio to devices connected to the UE. For clarity, the UE is commonly referred to as an MTC (machine type communication) UE or an IoT (Internet of Things) UE.

When the next generation system utilizes a cellular network or a third-party network, the next generation system can perform communication using a narrow band (hereinafter, NB-IoT communication). In this case, the narrow band may correspond to 180 kHz. A UE (hereinafter, NB-IoT UE) or an eNB transmits a single channel or a plurality of physical channels by multiplexing the channel(s) in a corresponding region. Meanwhile, the NB-IoT UE can perform communication even in such an area where channel environment is poor as under a bridge, under the sea, on the sea, and the like. In this case, in order to compensate for the poor channel environment, the NB-IoT UE may perform repetitive transmission on a specific channel (e.g., repetitive transmission during several TTIs) and/or perform power boosting. As an example of the power boosting, a region of a frequency resource to be transmitted on a specific band is more reduced to concentrate power per hour on a specific resource. For example, when a specific channel is transmitted via an RB (resource block) consisting of 12 REs, it may concentrate power to be distributed via the entire RB on a specific RE(s) by allocating the power to the specific RE instead of RE allocation in an RB unit. In particular, a scheme of performing communication by concentrating data and power on a single RE belonging to an RB is commonly referred to as a single-tone transmission scheme.

The present invention proposes a random access procedure using a single-tone PRACH and a method of performing the procedure. Yet, the technical idea of the present invention can be applied not only to the PRACH but also to a different channel. When FDM (frequency division multiplexing) is performed on a plurality of PRACH transmissions, it is apparent that the present invention can be extensively applied to a multi-tone scheme instead of the single-tone scheme. In the present invention, for clarity, assume that subcarrier spacing is reduced to 3.75 kHz from previous 15 kHz. And, PRACH for NB-IoT can be represented as NPRACH.

<Method of Allocating Subcarrier for PRACH>

In a next generation system, a plurality of subcarrier indexes can be allocated to transmit NPRACH. A set of subcarriers for transmitting a single NPRACH may be different from the entire subcarrier set. For example, it may use 12 subcarrier indexes to transmit a single NPRACH (in a hopping form), whereas the total number of subcarriers allocated by a serving cell to transmit NPRACH may exceed 12 (e.g., 24, 36, 48, etc.).

It may be able to signal a subcarrier offset for PRACH or a subcarrier starting position for PRACH within a carrier allocated for NB-IoT (e.g., a carrier consisting of 48 subcarriers). In this case, it is necessary to finally define a set(s) of subcarriers which are allocated to transmit PRACH. For example, when total 48 subcarriers exist in a carrier, a subcarrier index capable of being used as a starting position can be configured by 0, 12, 24, 36, 2, 18, 34, or the like. In particular, if a starting point subcarrier index corresponds to 2, 8, and 34, a partial region of a carrier can be utilized as a guard band.

If the total number of subcarriers is calculated from a subcarrier starting position which is configured in advance or configured via higher layer signaling, a subcarrier index may deviate from a carrier. In this case, (1) it may not allocate a subcarrier for transmitting PRACH to a region exceeding a carrier or (2) it may allocate a subcarrier from a subcarrier index 0 again or allocate a subcarrier after a guard band (e.g., subcarrier index 2) in consideration of the guard band.

In particular, the methods (1) and (2) can be applied only when a subcarrier offset is configured by 2, 18, or 34. If a guard band exists within NB-IoT carrier, a subcarrier index can be assigned to subcarriers except the guard band to allocate a frequency resource.

<RAR Transmission Technique>

When PRACH is transmitted to an eNB, the eNB can transmit a RAR (random access response) to a plurality of UEs. According to a legacy LTE system, MAC RARs have the same RA-RNTI for PRACH transmitted from the same time-frequency resource and the MAC RARs are simultaneously transmitted via PDCCH and PDSCH corresponding to the RA-RNTI.

Single-tone PRACH can be introduced to a next generation system. The PRACH transmission (hereinafter, NPRACH) may have a form supporting FDM and TDM. In particular, the NPRACH can be transmitted to a different time-frequency resource except a case that a plurality of NPRACHs are collided with each other. In particular, when NPRACHs are transmitted at the same time or when NPRACHs are detected at the same time, the NPRACHs may have a different RA-RNTI. MAC RAR can also be transmitted via a different PDCCH or a different PDSCH. In particular, PDSCH including the MAC RAR includes a single RAR within a TTI. However, as the number of UEs transmitting NPRACH at the same time increases, a problem of significantly occupying overhead of a corresponding cell may occur.

Hence, when NPRACHs are transmitted at the same time or when NPRACHs are detected at the same time, although a frequency resource or a subcarrier index is different, it may consider a form of transmitting MAC RAR messages via the same PDCCH and the same PDSCH. For example, in NB-IoT environment, when RA-RNTI is calculated, it may have (1) a form that a time domain resource is used as a parameter only and a frequency domain resource is not considered.

Or, when RA-RNTI is calculated, it may have (2) a form that the frequency domain resource has the same RA-RNTI value by biding a plurality of subcarrier indexes or a plurality of frequency resources while a time domain resource and/or a frequency domain resource is used as a parameter. More specifically, a frequency resource group is defined and indexes of the frequency resource group are utilized for calculating RA-RNTI. The frequency resource group can be sequentially configured in advance or can be configured via higher layer.

In case of considering a plurality of coverage levels, RA-RNTI may additionally consider a repetition count or a coverage level. And, a frequency resource set in which PRACH is to be transmitted can be independently configured according to a coverage level or a frequency resource group. In this case, a different frequency resource set is comprehended as a frequency resource group and a group index can be utilized for calculating RA-RNTI.

As a different method, although RA-RNTI is different, if NPRACHs are transmitted or detected at the same time, it may consider transmitting MAC RAR via the same PDCCH and the same PDSCH. In particular, when MAC RARs are transmitted together, NPRACHs corresponding to the MAC RARs can be restricted to the same coverage level. In particular, if NPRACHs for a plurality of coverage levels are transmitted or detected at the same time, it may individually transmit MAC RAR by allocating a different PDCCH and a different PDSCH.

Meanwhile, when NPRACH is transmitted via a different frequency resource in the same coverage level or the same frequency resource group, MAC RAR corresponding to the NPRACH is transmitted on PDCCH and PDSCH. In this case, the PDCCH and the PDSCH can be scrambled by a representative RA-RNTI. The representative RA-RNTI may correspond to a smallest RA-RNTI among NPRACHs transmitted or detected at the same time. Or, the representative RA-RNTI can be fixed with a specific RA-RNTI irrespective of whether or not transmission is performed to reduce blind decoding. The specific RA-RNTI may correspond to RA-RNTI corresponding to a lowest resource index among NPRACH frequency resources configured via higher layer.

In case of considering transmitting NPRACH on a different PDCCH and a different PDSCH with an individual RA-RNTI according to a subcarrier index, when a RAR window is configured to distribute load, a starting point of the RAR window can be differently configured according to a subcarrier index (or frequency resource) at which the NPRACH is transmitted or detected and/or a coverage level. The subcarrier index (or a frequency resource) at which the NPRACH is transmitted or detected may correspond to a starting subcarrier index or an ending subcarrier index of the NPRACH.

When a starting position of an RAR window is adjusted, it is preferable to configure each of RAR windows not to be overlapped on a time axis. For example, when RAR window sizes for subcarrier indexes of the N number of NPRACHs correspond to M_1, M_2, . . . , M_N, a starting position of an n^{th} RAR window may correspond to (k+M_1+M_2+ . . . +M_n−1)^{th} subframe from a subframe at which NPRACH transmission ends. In this case, the k may correspond to 3.

When both PDCCH and PDSCH for RAR are included in a RAR window, if it fails to detect an appropriate RAR in the RAR window, PRACH retransmission timing can be excessively delayed due to TDM between RAR windows. Hence, it may divide a RAR window into two regions. One region is used as a region for PDCCH and another region can be used as a region for PDSCH. Hence, it may consider performing TDM by making a RAR window for PDCCH appear prior to a RAR window for PDSCH in time. In this case, if a specific UE fails to detect an appropriate PDCCH in the RAR window for PDCCH, the UE may prepare to retransmit PRACH until a predetermined point from the timing at which the RAR window for PDCCH ends (e.g., when an end of the RAR window corresponds to a subframe #n, until a subframe #(n+4)).

Meanwhile, when MAC RARs are transmitted at the same time for the same coverage level and a different RAR PDCCH/PDSCH is transmitted for a different coverage level, the aforementioned scheme can be extensively applied to a case of performing multiplexing on RAR PDCCH/PDSCH between coverage levels different from each other.

In addition, when a plurality of MAC RARs are included in PDSCH corresponding to a (representative) RA-RNTI, it may be necessary to have a tool for distinguishing a plurality of the MAC RARs from each other. In case of performing single-tone PRACH transmission, it may not consider CDM. Hence, it may be able to identify a MAC RAR using a frequency resource or a subcarrier index at which transmission of NPRACH starts or ends. If RA-RNTIs are different from each other, it may be able to distinguish a plurality of the MAC RARs from each other using RA-RNTI. Information for MAC RAR distinction can be included in a corresponding (sub) header.

<Message 3 (Msg3) Transmission Technique>

Msg3 can be transmitted according to UL grant information included in each MAC RAR message after RAR is transmitted. In NB-IoT environment of a next generation system, since transmission is performed on a limited narrow band (e.g., 200 kHz or 180 kHz), if a plurality of msg3 are transmitted at the same time, it is inefficient in terms of resource utilization. Hence, it may consider transmitting transmission resources by distributing the transmission resources to a time axis in the next generation system. For example, it may consider a case that a UL delay field of a UL grant included in RAR is to be extended.

More specifically, the UL delay field can be configured by the maximum number of factors capable of being transmitted at a single point of NPRACH such as 2, 3, 4, or 12-bit size rather than 1-bit size. The bit sizes can be configured in advance or can be configured via higher layer signaling. For example, when the UL delay field is configured by 2-bit size and an index of the last subframe in which PDSCH including RAR is transmitted corresponds to #n, if a value of the UL delay field corresponds to 00, it may indicate a subframe #(n+k1) (k1 is equal to or greater than 6) as a subframe capable of transmitting PUSCH. Similarly, if a value of the UL delay field corresponds to 01, it may indicate a subframe #(n+k1+M). If a value of the UL delay field corresponds to 10, it may indicate a subframe #(n+k1+2M). If a value of the UL delay field corresponds to 11, it may indicate a subframe #(n+k1+3M). In this case, the M may correspond to a repetition count for Msg3 or a representative Msg3 repetition count configured by a higher layer in advance in consideration of a situation that a plurality of Msg3 are TDMed.

As a different method, it may consider a case that a scheduling unit for Msg3 is configured in advance or is configured via higher layer (e.g., SIB). The scheduling unit can be independently configured according to at least one selected from the group consisting of information on whether or not a transmission corresponds to a single-tone transmission, a coverage level for Msg3, and subcarrier spacing for Msg3. The scheduling unit can include a time domain resource and/or a frequency domain resource. For example, the scheduling unit can be mapped to the entire narrowband to differently configure transmission timing. Or, the scheduling unit can be mapped to a single tone or a plurality of tones (subcarriers) to differently configure transmission timing.

A configured scheduling unit can be indicated by a UL grant included in a RAR. For example, a start point of the scheduling unit can be configured by a unit of the L number of subcarriers (e.g., 6 subcarriers) and a unit of the M number of subframes in a subframe. And, a time resource and a frequency resource for transmitting Msg3 can be configured via resource allocation field included in a UL grant. The M may correspond to a repetition count for the Msg3 or a representative value configured in advance or configured via higher layer (e.g., SIB) in consideration of TDM.

If a preamble for performing CDM is introduced to single-tone PRACH transmission, the subcarrier index can be comprehended as a combination of a subcarrier index and a preamble index. Or, the principle of the present invention can be extensively applied to a preamble index.

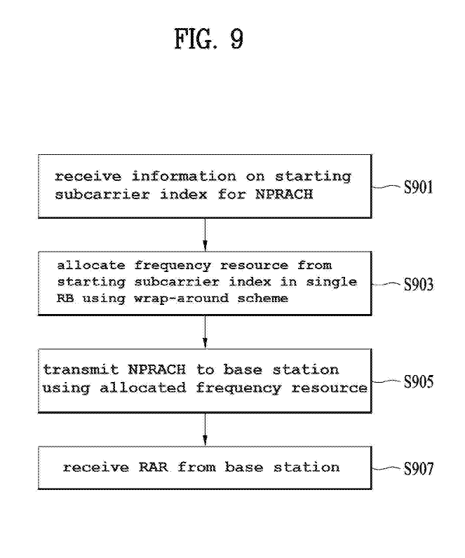

FIG. 9 is a flowchart illustrating an example of performing a random access procedure for narrow band communication according to an embodiment of the present invention.

Referring to FIG. 9, in the step S901, a UE can receive information on a starting subcarrier index for a random access channel from a network or a base station.

Subsequently, in the step S903, the UE can allocate a frequency resource to the random access channel as many as the predetermined number of subcarriers from the starting subcarrier index in an order of a subcarrier index in a single resource block. In particular, if a subcarrier index to be assigned is greater than the maximum subcarrier index in the single resource block, the remaining frequency resources are allocated to the random access channel from a specific subcarrier in an order of a subcarrier index in the single resource block. In particular, it may be able to allocate a frequency resource using a wrap-around scheme.

In particular, it may be able to configure at least one guard band in the single resource block to prevent interference from a legacy system. In this case, in the step S903, it is preferable that the specific subcarrier corresponds to a subcarrier of a minimum index except a subcarrier designated as the at least one guard band in the single resource block.

In the step S905, the UE transmits the random access channel to the base station using an allocated frequency resource. In the step S907, the UE receives a random access response signal in response to the random access channel. In particular, the random access response signal can be masked with an identifier which is calculated using a time resource index at which the random access channel is transmitted only. And, a time resource for receiving the random access response signal can be determined based on the starting subcarrier index.

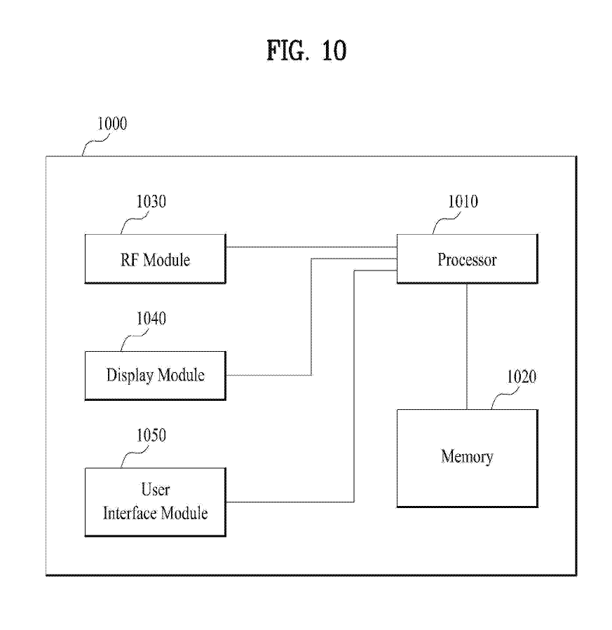

FIG. 10 is a block diagram of a communication apparatus according to an embodiment of the present invention.

Referring to FIG. 10, a communication apparatus 1000 includes a processor 1010, a memory 1020, a Radio Frequency (RF) module 1030, a display module 1040 and a user interface module 1050.

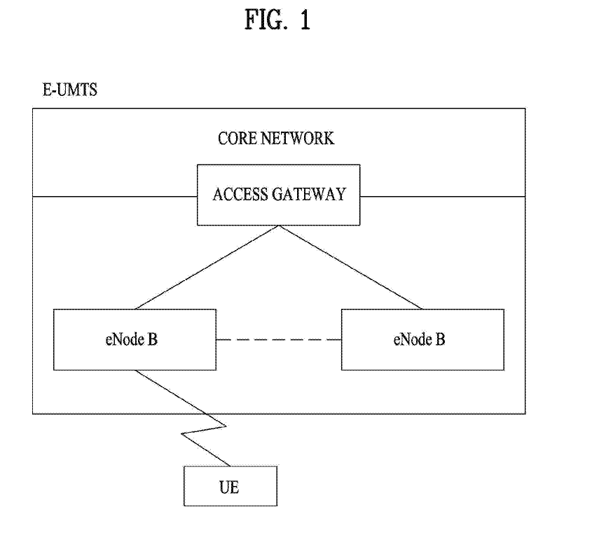

The communication apparatus 1000 is shown for convenience of description and some modules thereof may be omitted. In addition, the communication apparatus 1000 may further include necessary modules. In addition, some modules of the communication apparatus 1000 may be subdivided. The processor 1010 is configured to perform an operation of the embodiment of the present invention described with respect to the drawings. For a detailed description of the operation of the processor 1010, reference may be made to the description associated with FIGS. 1 to 9.

The memory 1020 is connected to the processor 1010 so as to store an operating system, an application, program code, data and the like. The RF module 1030 is connected to the processor 1010 so as to perform a function for converting a baseband signal into a radio signal or converting a radio signal into a baseband signal. The RF module 1030 performs analog conversion, amplification, filtering and frequency up-conversion or inverse processes thereof. The display module 1040 is connected to the processor 1010 so as to display a variety of information. As the display module 1040, although not limited thereto, a well-known device such as a Liquid Crystal Display (LCD), a Light Emitting Diode (LED), or an Organic Light Emitting Diode (OLED) may be used. The user interface module 1050 is connected to the processor 1010 and may be configured by a combination of well-known user interfaces such as a keypad and a touch screen.

The above-described embodiments are proposed by combining constituent components and characteristics of the present invention according to a predetermined format. The individual constituent components or characteristics should be considered to be optional factors on the condition that there is no additional remark. If required, the individual constituent components or characteristics may not be combined with other components or characteristics. Also, some constituent components and/or characteristics may be combined to implement the embodiments of the present invention. The order of operations to be disclosed in the embodiments of the present invention may be changed. Some components or characteristics of any embodiment may also be included in other embodiments, or may be replaced with those of the other embodiments as necessary. Moreover, it will be apparent that some claims referring to specific claims may be combined with other claims referring to the other claims other than the specific claims to constitute the embodiment or add new claims by means of amendment after the application is filed.

The above-mentioned embodiments of the present invention are disclosed on the basis of a data communication relationship between a base station and a user equipment. Specific operations to be conducted by the base station in the present invention may also be conducted by an upper node of the base station as necessary. In other words, it will be obvious to those skilled in the art that various operations for enabling the base station to communicate with the user equipment in a network composed of several network nodes including the base station will be conducted by the base station or other network nodes than the base station. The term “Base Station” may be replaced with the terms fixed station, Node-B, eNode-B (eNB), or access point as necessary.

The embodiments of the present invention can be implemented by a variety of means, for example, hardware, firmware, software, or a combination thereof. In the case of implementing the present invention by hardware, the present invention can be implemented through application specific integrated circuits (ASICs), digital signal processors (DSPs), digital signal processing devices (DSPDs), programmable logic devices (PLDs), field programmable gate arrays (FPGAs), a processor, a controller, a microcontroller, a microprocessor, etc.

If operations or functions of the present invention are implemented by firmware or software, the present invention can be implemented in the form of a variety of formats, for example, modules, procedures, functions, etc. The software code may be stored in a memory unit so as to be driven by a processor. The memory unit may be located inside or outside of the processor, so that it can communicate with the aforementioned processor via a variety of well-known parts.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

Although a method of performing a random access procedure for single-tone transmission in a wireless communication system and an apparatus therefor are described with reference to examples applied to 3GPP LTE system, it may be applicable to various kinds of wireless communication systems as well as the 3GPP LTE system.

1-10. (canceled)

11. A method of performing a random access procedure for a narrow band communication by a base station (BS) in a wireless communication system, the method comprising:
receiving a plurality of random access preambles for the narrow band communication in a subframe from user equipments (UEs);
determining an identifier for the random access procedure based on an index of the subframe, regardless of indexes of subcarriers on which the plurality of random access preambles are received;
transmitting a random access response (RAR) by using the determined identifier to the UEs, as a response of the plurality of random access preambles.

12. The method of claim 11, wherein transmitting the RAR comprises transmitting a data channel including the RAR and a control channel for the data channel to the UEs,
wherein the control channel and the data channel are masked with the identifier for the random access procedure.

13. The method of claim 11, wherein each of the plurality of random access preambles is received on a single subcarrier in the subframe.

14. A base station (BS) supporting a narrow band communication in a wireless communication system, comprising:
a radio frequency (RF) unit; wireless communication module; and
a processor connected with the RF unit,
wherein the processor is configured to receive a plurality of random access preambles for a narrow band communication in a subframe from user equipments (UEs), determine an identifier for a random access procedure based on an index of the subframe regardless of indexes of subcarriers on which the plurality of random access preambles are received, and transmit a random access response (RAR) by using the determined identifier to the UEs, as a response of the plurality of random access preambles.

15. The BS of claim 14, wherein the processor is further configured to transmit a data channel including the RAR and a control channel for the data channel to the UEs,
wherein the control channel and the data channel are masked with the identifier for the random access procedure.

16. The BS of claim 14, wherein each of the plurality of random access preambles is received on a single subcarrier in the subframe.
